(19) United States
(12) Patent Application Publication
(10) Pub. No.: US 2017/0057122 A1
(43) Pub. Date: Mar. 2, 2017

(54) APPARATUS AND METHOD FOR PROCESSING SINGLE CUP BEVERAGE DISPENSERS

(71) Applicant: Andrew GRANTHAM, Copper Cliff (CA)

(72) Inventor: Andrew GRANTHAM, Copper Cliff (CA)

(21) Appl. No.: 15/118,649

(22) PCT Filed: Feb. 13, 2015
(86) PCT No.: PCT/IB2015/001098

§ 371 Date: Aug. 12, 2016

Related U.S. Application Data
(60) Provisional application No. 61/939,601, filed on Feb. 13, 2014.

(51) Int. Cl. B29B 17/02; B67B 7/46; A47J 31/44

(52) U.S. Cl. CPC B29B 17/02; A47J 31/44; B67B 7/30

(57) ABSTRACT

An apparatus has a housing configured to receive a single serving beverage dispenser comprising a receptacle, a compostable product within the receptacle and a lid sealing an end of the receptacle. A cutter assembly is positioned at an end of the housing. The cutter assembly has a lid cutter and a receptacle cutter. A grip ring is configured to rotate the cutter assembly in response to manual manipulation, such that the lid cutter separates the lid from the receptacle and the receptacle cutter separates a top portion of the receptacle from a bottom portion of the receptacle. The housing has an open end through which the bottom portion of the receptacle is removed and a lid end through which the lid and top portion of the receptacle are removed.

### CROSS-REFERENCE TO RELATED APPLICATION

This application claims priority to U.S. Provisional Patent Application Ser. No. 61/939,601, filed Feb. 13, 2014, the contents of which are incorporated herein by reference.

### FIELD OF THE INVENTION

This invention relates generally to single cup beverage dispensers. More particularly, this invention relates to techniques for processing single cup beverage dispensers to produce separately recyclable components.

### BACKGROUND OF THE INVENTION

There is a growing use of single cup beverage dispensers. For example, Keurig Green Mountain, Inc., of Waterbury, Vt. sells K-Cup® single cup coffee dispensers. Such dispensers comprise a receptacle, coffee within the receptacle and a metallic lid. Ideally, each of these components would be recycled in a separate manner. The receptacle, which is typically plastic, should be recycled in one manner. The coffee is a compostable product and as such should be composted. The lid, a metallic product, should be recycled in a separate manner.

Notwithstanding the good intentions of most consumers, it is difficult for such consumers to recycle these individual components in an appropriate manner. Accordingly, it would be desirable to provide techniques for processing single cup beverage dispensers to produce separately recyclable components.

### SUMMARY OF THE INVENTION

An apparatus has a housing configured to receive a single serving beverage dispenser comprising a receptacle, a compostable product within the receptacle and a lid sealing an end of the receptacle. A cutter assembly is positioned at an end of the housing. The cutter assembly has a lid cutter and a receptacle cutter. A grip ring is configured to rotate the cutter assembly in response to manual manipulation, such that the lid cutter separates the lid from the receptacle and the receptacle cutter separates a top portion of the receptacle from a bottom portion of the receptacle. The housing has an open end through which the bottom portion of the receptacle is removed and a lid end through which the lid and top portion of the receptacle are removed.

### BRIEF DESCRIPTION OF THE FIGURES

The invention is more fully appreciated in connection with the following detailed description taken in conjunction with the accompanying drawings, in which:

FIG. 1 is an exploded view of an apparatus configured in accordance with an embodiment of the invention.

FIG. 2 is a detailed view of a cutter assembly utilized in accordance with an embodiment of the invention.

FIG. 3 is a detailed view of a shuttle assembly utilized in accordance with an embodiment of the invention.

Like reference numerals refer to corresponding parts throughout the several views of the drawings.

### DETAILED DESCRIPTION OF THE INVENTION

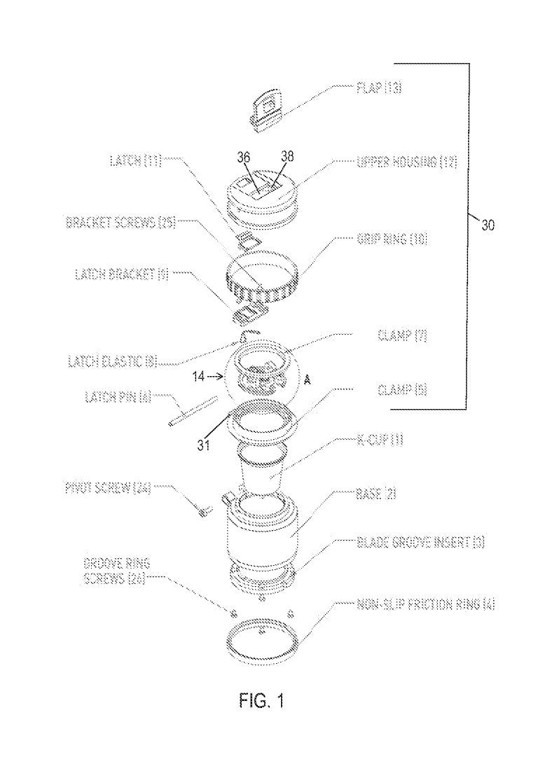

FIG. 1 is an exploded view of an apparatus configured in accordance with an embodiment of the invention. The apparatus includes a base or housing 2 configured to receive a single serving beverage dispenser 1. The single serving beverage dispenser 1 comprises a receptacle, a compostable product within the receptacle and a lid sealing an end of the receptacle. In one embodiment, the single serving beverage dispenser is a K-Cup®. However, the invention is applicable to any single serving beverage dispenser containing a compostable product, such as coffee, tea and the like. Indeed, the techniques of the invention need not be limited to single serving portions or beverages. Rather, techniques of the invention may be applicable to any container with compostable material.

A blade groove insert or receptacle cutter grove insert 3 is positioned on an interior surface of base 2. The insert 3 may be secured with screws 26. The insert 3 may have an associated non-slip friction ring 4.

A lid assembly 30 has a first clamp 5 with an aperture to receive a pivot screw 24, which allows the entire lid assembly to pivot with respect to the pivot screw 24. The pivot screw passes through an aperture 31 formed in the first clamp 5. Multiple pivot screws may be used.

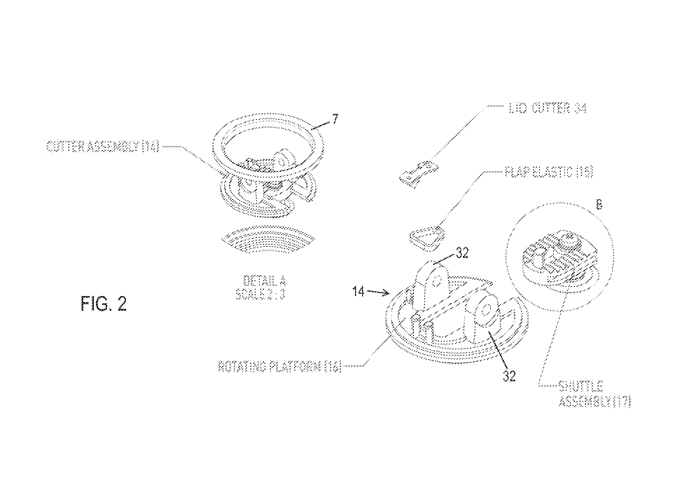

Positioned above the first clamp 5 is a cutter assembly 14. Details of the cutter assembly 14 are shown in FIG. 2. The cutter assembly 14 includes a second clamp 7. The cutter assembly 14 also includes a rotating platform 16. Mounts 32 are positioned on the rotating platform 16. The mounts 32 receive the latch pin 6. The rotating platform 16 also supports flap elastic 15 and a lid cutter 34. Flap elastic 15 provides a reciprocal force after the flap 13 is released from latch 11. Alternately, a spring may be used. The lid cutter 34 includes a downward protruding blade. As discussed below, the cutting assembly 14 is responsive to rotational force from the grip ring 10, which causes the lid cutter 34 to peripherally cut the lid.

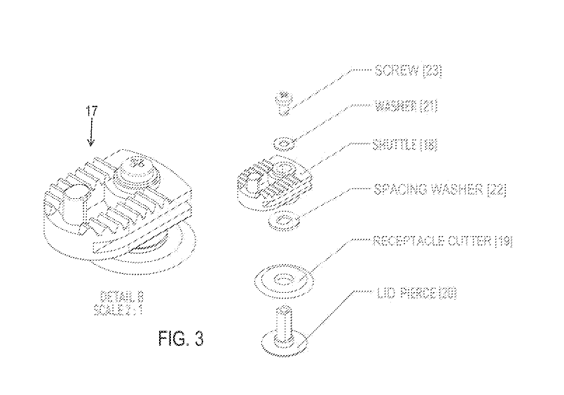

The rotating platform 16 also supports a shuttle assembly 17, the details of which are shown in FIG. 3. Shuttle assembly 17 includes a shuttle 18, which coordinates movement of the receptacle cutter 19 from a first position to a second position adjacent to the receptacle cutter groove 3, as discussed below. A screw 23 passes through a washer 21 and washer 22 for engagement with a lid pierce 20, the operation of which is discussed below. A receptacle cutter 19 is positioned above the lid pierce 20. The cutting assembly 14 is responsive to rotational force from the grip ring 10, which causes the receptacle cutter 19 to peripherally cut the receptacle. The lid cutter 34 is downward protruding, while the receptacle cutter 19 is peripherally protruding.

Returning to FIG. 1, the lid assembly 30 also includes a grip ring 10, which surrounds the cutter assembly 14. A latch bracket 9 secures a latch 11. The latch 11 latches a flap 13. The flap 13 is positioned on an upper housing 12. The upper housing 12 may have an aperture 36 with a pivot structure 38 (male part) that engages a pivot aperture (female part) associated with the flap 13. Latch 11 pivots about the latch pin 6, which is fixed to the rotating platform between the mounts 32. The flap has a pinion configured for engagement with the shuttle 18. Rotation of the flap 13 causes the receptacle cutter 19 to move from a first position to a second position adjacent to the receptacle cutter groove 3. Once the flap 13 is engaged with the latch 11, the grip ring 10 may be manually manipulated (e.g., rotated), which causes the cutter assembly 14 to rotate. As a result, the lid cutter 34 separates the lid from the receptacle and the receptacle cutter 19 separates a top portion of the receptacle from the bottom portion of the receptacle. The base 2 is open at the end opposite the lid assembly 30. The bottom portion of the receptacle is removed through the open end. The separated lid and top portion of the receptacle are removed from the opposite end after the lid assembly 30 is pivoted to an open position along pivot screw 24.

Utilization of the disclosed apparatus may be characterized as follows. A single beverage dispenser (e.g., a K-Cup®) 1 is placed in the base or housing 2. The lid assembly 30 is then rotated about one or more pivot screws 24. As the lid assembly 30 rotates down, the cup clamp 5 contacts the top rim of the dispenser or receptacle 1. Simultaneously, the lid pierce 20 punctures the lid and spreads the lid to allow the receptacle cutter 19 to enter the interior of the receptacle 1. Alternately, the lid cutter 34 may be configured to puncture and spread the lid.

When the lid assembly is fully rotated down, the flap 13 can be rotated downward. As the flap 13 rotates, a pinion on the flap pushes the shuttle 17 forward and into the inside of the receptacle wall. The receptacle cutter 19 attached to the shuttle 17 is driven through the wall of the receptacle 1. The receptacle cutter 19 slides into a groove formed by the housing 2 and receptacle cutter groove 3. The blade 19 in this groove 3 prevents the lid from opening and compresses the lid assembly against the dispenser and base 2. When the flap 3 is fully rotated down it is held in place by the latch 11. Now the user can grab the grip ring 10 on the upper housing 12 and rotate the lid assembly 30. By rotating the lid assembly 30 the receptacle cutter 19 spins around the perimeter of the receptacle, cutting through the wall, separating the cup's lid from the lower portion. As the lid assembly is rotated the lid is also cut and separated by the lid cutter 16.

The user can now lift the housing 2 to access the separated lower cup. That is, by lifting the housing, the separated lower bottom portion of the receptacle is exposed, since the housing 2 is open at its bottom side. At this point, the lower portion of the receptacle with compostable material is separated and can be composted. For example, the compostable material may be designated for compost, while the receptacle may be designated for plastic recycling. The lid can be opened by sliding the latch 11, which allows the flap 13 to move back to a vertical position (e.g., responsive to the force from the flap plastic 15). This movement disengages the receptacle cutter 19 from the groove 3 and receptacle 1. That is, reverse motion of the shuttle 18 re-positions the receptacle cutter 19 to its original position. The lid assembly 30 can now be rotated opened. The separated lid is now accessible and can be recycled. Similarly, the separated receptacle rim can now be removed from the housing 2 and be disposed. For example, the lid may be recycled with metallic materials, while the receptacle rim is recycled with plastic materials.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. An apparatus, comprising:
a housing configured to receive a single serving beverage dispenser comprising a receptacle, a compostable product within the receptacle and a lid sealing an end of the receptacle;
a cutter assembly positioned at an end of the housing, the cutter assembly including a lid cutter and a receptacle cutter; and
a grip ring configured to rotate the cutter assembly in response to manual manipulation, such that the lid cutter separates the lid from the receptacle and the receptacle cutter separates a top portion of the receptacle from a bottom portion of the receptacle;
wherein the housing has an open end through which the bottom portion of the receptacle is removed and a lid end through which the lid and top portion of the receptacle are removed.

2. The apparatus of claim 1 wherein the housing further comprises a receptacle cutter groove positioned on an interior surface of the housing.

3. The apparatus of claim 2 wherein the cutter assembly further comprises a shuttle to coordinate movement of the receptacle cutter from a first position to a second position adjacent to the receptacle cutter groove.

4. The apparatus of claim 3 wherein there receptacle cutter moves through the receptacle cutter groove in response to the manual manipulation.

5. The apparatus of claim 3 further comprising an upper housing positioned over the cutter assembly, the upper housing comprising a flap with a pinion configured for engagement with the shuttle, rotation of the flap causing the receptacle cutter to move from the first position to the second position.

6. The apparatus of claim 1 wherein the cutter assembly further comprises a lid pierce.
